(19) United States
(12) Patent Application Publication
(10) Pub. No.: US 2019/0196726 A1
(43) Pub. Date: Jun. 27, 2019

(54) DYNAMIC RANDOM ACCESS MEMORY AND METHOD OF OPERATING THE SAME

(71) Applicant: NANYA TECHNOLOGY CORPORATION, New Taipei City (TW)

(72) Inventors: CHUNG-HSUN LEE, New Taipei City (TW); Hsien-Wen Liu, Luzhu Township (TW)

(21) Appl. No.: 15/918,385

(22) Filed: Mar. 12, 2018

Related U.S. Application Data
(60) Provisional application No. 62/610,344, filed on Dec. 26, 2017.

(51) Int. Cl. G06F 3/06

(52) U.S. Cl. CPC G06F 3/0619; G06F 3/0673; G06F 3/0659

(57) ABSTRACT

The present disclosure provides a dynamic random-access memory (DRAM) with a data correction function and a method of operating the same. The DRAM includes a memory array; a control circuit configured to receive an inputting data and a temperature signal; a first error-correction code (ECC1) circuit configured to generate a first encoded data from the inputting data; and a second error-correction code (ECC2) circuit configured to generate a second encoded data from the inputting data.

### PRIORITY CLAIM AND CROSS-REFERENCE

This application claims priority of U.S. provisional application Ser. No. 62/610,344 filed on Dec. 26, 2017, which is incorporated herein by reference in its entirety.

### TECHNICAL FIELD

The present disclosure relates to a dynamic random-access memory (DRAM) and a method of operating the same, and more particularly, to a dynamic random-access memory with a data correction function and a method of operating the same.

### DISCUSSION OF THE BACKGROUND

A DRAM is a type of random access memory that stores each bit of data in a separate capacitor. A simplest DRAM cell comprises a single N-type metal-oxide-semiconductor (NMOS) transistor and a single capacitor. If charge is stored in the capacitor, the cell is said to store a logic HIGH, depending on the convention used. If no charge is present, the cell is said to store a logic LOW. Because the charge in the capacitor dissipates over time, DRAM systems require additional refreshing circuitries to periodically refresh the charge stored in the capacitors. Since a capacitor can store only a very limited amount of charge, in order to quickly distinguish the difference between a logic “1” and a logic “0,” two bit lines (BLs) are typically used for each bit, wherein the first bit line in the bit line pair is known as a bit line true (BLT) and the other bit line in the bit line pair is the bit line complement (BLC). The single NMOS transistor's gate is controlled by a word line (WL).

This Discussion of the Background section is provided for background information only. The statements in this Discussion of the Background are not an admission that the subject matter disclosed in this section constitutes prior art to the present disclosure, and no part of this Discussion of the Background section may be used as an admission that any part of this application, including this Discussion of the Background section, constitutes prior art to the present disclosure.

### SUMMARY

One aspect of the present disclosure provides a DRAM, comprising a memory array; a control circuit configured to receive an inputting data and a temperature signal; a first error-correction code (ECC1) circuit configured to generate a first encoded data from the inputting data; and a second error-correction code (ECC2) circuit configured to generate a second encoded data from the inputting data.

In some embodiments, the ECC1 circuit is configured to generate the first encoded data when the temperature signal indicates an ambient temperature that is lower than a threshold temperature.

In some embodiments, the ECC2 circuit is configured to generate the second encoded data when the temperature signal indicates an ambient temperature that is higher than a threshold temperature.

In some embodiments, the control circuit is configured to determine which one of the ECC1 circuit and the ECC2 circuit is to be enabled.

In some embodiments, the DRAM further comprises a temperature sensor configured to generate the temperature signal representing the ambient temperature.

In some embodiments, the control circuit is configured to receive a write command.

In some embodiments, one of the ECC1 circuit and the ECC2 circuit is configured to perform a writing operation to the memory array after receiving the write command and one of the first encoded data and the second encoded data.

Another aspect of the present disclosure provides a DRAM, comprising a memory array; a control circuit configured to receive an inputting data and a temperature signal; a first error-correction code (ECC1) circuit configured to generate a first encoded data from the inputting data: and a second error-correction code (ECC2) circuit configured to generate a second encoded data from the inputting data, wherein the ECC1 circuit is enabled when the temperature signal indicates an ambient temperature that is lower than a threshold temperature, and the ECC2 circuit is enabled when the temperature signal indicates an ambient temperature that is higher than the threshold temperature.

In some embodiments, the control circuit comprises a temperature-determining circuit configured to interpret the temperature signal representing the ambient temperature.

In some embodiments, the control circuit further comprises a distributor configured to determine which one of the ECC1 circuit and the ECC2 circuit is to be enabled.

In some embodiments, the DRAM further comprises a temperature sensor configured to generate the temperature signal representing the ambient temperature.

In some embodiments, the control circuit is configured to receive a write command.

In some embodiments, one of the ECC1 circuit and the ECC2 circuit is configured to perform a writing operation to the memory array after receiving the write command and one of the first encoded data and the second encoded data.

In some embodiments, the memory array comprises at least one weak row and at least one strong row.

In some embodiments, the first encoded data is stored in the weak row.

In some embodiments, the second encoded data is stored in the strong row.

Another aspect of the present disclosure provides a method of operating a dynamic random-access memory, comprising the steps of: receiving an inputting data; receiving a temperature signal; interpreting the temperature signal indicating an ambient temperature; determining whether the ambient temperature is lower than a threshold temperature; and enabling one of at least two error-correction code circuits based on the determining result.

In some embodiments, the step of enabling one of at least two error-correction code circuits based on the determining result comprises encoding the inputting data to generate an encoded data, and the method further comprises a step of writing the encoded data to a memory array.

In some embodiments, the step of writing the encoded data to a memory array comprises writing the encoded data in weak rows of the memory array if the ambient temperature is lower than the threshold temperature.

In some embodiments, the step of writing the encoded data to a memory array comprises writing the encoded data in strong rows of the memory array if the ambient temperature is not lower than the threshold temperature.

In a comparative DRAM, there is only one error-correction code (ECC) circuit to encode the inputting data; in contrast, in the DRAM of the present disclosure, there are two error-correction code (e.g., ECC1 and ECC2) circuits. Consequently, one error-correction code circuit having better correcting ability can be optimally applied to a situation, for example, a higher temperature for detecting and correcting, while another error-correction code circuit having normal correcting ability can be optimally applied to another situation, for example, a normal temperature for detecting and correcting.

The foregoing has outlined rather broadly the features and technical advantages of the present disclosure in order that the detailed description of the disclosure that follows may be better understood. Additional features and technical advantages of the disclosure are described hereinafter and form the subject of the claims of the disclosure. It should be appreciated by those skilled in the art that the concepts and specific embodiments disclosed may be utilized as a basis for modifying or designing other structures, or processes, for carrying out the purposes of the present disclosure. It should also be realized by those skilled in the art that such equivalent constructions do not depart from the spirit or scope of the disclosure as set forth in the appended claims.

### BRIEF DESCRIPTION OF THE DRAWINGS

A more complete understanding of the present disclosure may be derived by referring to the detailed description and claims. The disclosure should also be understood to be connected to the figures' reference numbers, which refer to similar elements throughout the description.

FIG. 1 is a block diagram of a comparative DRAM.

FIG. 2 is a block diagram of a comparative DRAM including an error-correction code (ECC) circuit.

FIG. 3 is a flow chart of a method of operating the comparative DRAM shown in FIG. 2.

FIG. 4 is a schematic block diagram illustrating a DRAM, in accordance with some embodiments of the present disclosure.

FIG. 5 is a flow chart of a method of operating the DRAM shown in FIG. 4 in accordance with some embodiments of the present disclosure.

FIG. 6 is a schematic block diagram illustrating a DRAM, in accordance with some embodiments of the present disclosure.

FIG. 7 is a flow chart of a method of operating the DRAM shown in FIG. 6 in accordance with some embodiments of the present disclosure.

FIG. 8 is a schematic block diagram illustrating a DRAM, in accordance with some embodiments of the present disclosure.

FIG. 9 is a schematic block diagram illustrating an operation of the DRAM shown in FIG. 8, in accordance with some embodiments of the present disclosure.

FIG. 10 is a schematic block diagram illustrating another operation of the DRAM shown in FIG. 8, in accordance with some embodiments of the present disclosure.

FIG. 11 is a flow chart of a method of operating the DRAM shown in FIG. 8 in accordance with some embodiments of the present disclosure.

### DETAILED DESCRIPTION

Embodiments, or examples, of the disclosure illustrated in the drawings are now described using specific language. It shall be understood that no limitation of the scope of the disclosure is hereby intended. Any alteration or modification of the described embodiments, and any further applications of principles described in this document, are to be considered as normally occurring to one of ordinary skill in the art to which the disclosure relates. Reference numerals may be repeated throughout the embodiments, but this does not necessarily mean that feature(s) of one embodiment apply to another embodiment, even if they share the same reference numeral.

It shall be understood that, although the terms first, second, third, etc. may be used herein to describe various elements, components, regions, layers or sections, these elements, components, regions, layers or sections are not limited by these terms. Rather, these terms are merely used to distinguish one element, component, region, layer or section from another region, layer or section. Thus, a first element, component, region, layer or section discussed below could be termed a second element, component, region, layer or section without departing from the teachings of the present inventive concept.

The terminology used herein is for the purpose of describing particular exemplary embodiments only and is not intended to be limited to the present inventive concept. As used herein, the singular forms “a,” “an” and “the” are intended to include the plural forms as well, unless the context clearly indicates otherwise. It shall be further understood that the terms “comprises” and “comprising,” when used in this specification, point out the presence of stated features, integers, steps, operations, elements, or components, but do not preclude the presence or addition of one or more other features, integers, steps, operations, elements, components, or groups thereof

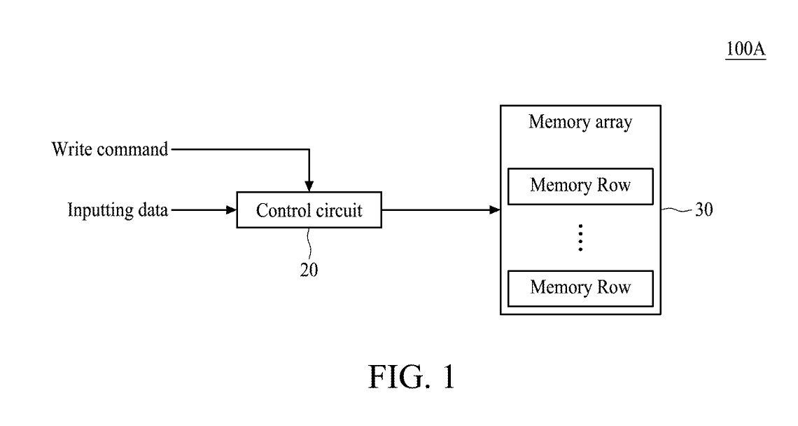

FIG. 1 is a block diagram of a comparative DRAM 100A. As shown in FIG. 1, the DRAM 100A includes a memory array 30 and a control circuit 20 connected to the memory array 30. The memory array 30 includes a plurality of memory rows and is configured to store a data, for example, a data from an external permanent hard disk. The control circuit 20 is configured to receive an inputting data from an external device and a write command from an external device. For example, the external device providing the inputting data can be a peripheral device using the DMA (Direct Memory Access) or another memory array (different memory bank), and the external device providing the write command can be a controller. The control circuit 20 performs a writing operation to write the inputting data to the memory rows of the memory array 30 after receiving the write command and the inputting data.

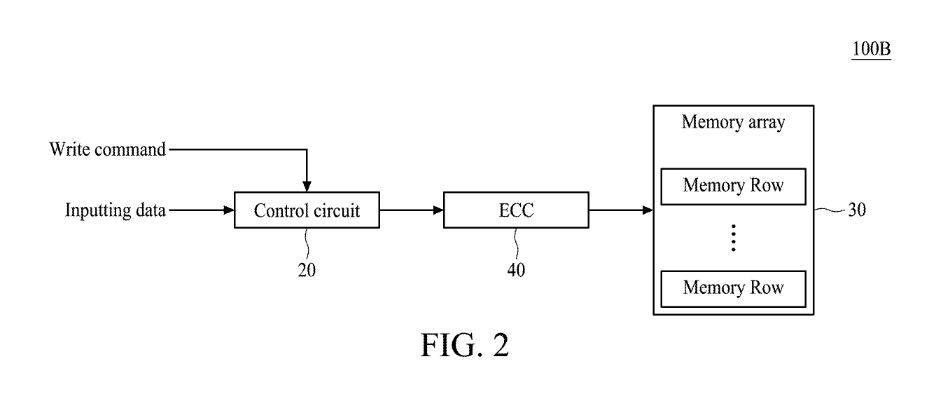

FIG. 2 is a block diagram of a comparative DRAM 100B including an error-correction code (ECC) circuit 40. Referring to FIG. 2 and FIG. 1, it is shown that the ECC circuit 40 is arranged between the control circuit 20 and the memory array 30. The control circuit 20 transmits the inputting data and the write command to the ECC circuit 40. The ECC circuit 40 encodes the inputting data and then performs a writing operation to write the encoded data to the memory array 30 according to the assigned memory address after receiving the write command.

The “encode” process is a mechanism for assuring data integrity by adopting extra bit(s) combined with the original data, for example, the inputting data and an algorithm (e.g., Hamming codes), which functions to assure the consistency between the data written to the memory array 30 and that read from the memory array 30. Accordingly, the ECC 40 has error detecting and error correcting abilities (known as soft error recovery ability).

Because the ECC circuit 40 is incorporated in the DRAM 100B, the data integrity and the data accuracy of the DRAM 100B can be ensured, although the DRAM 100B requires some amount of time for accessing the memory array 30 both in the writing cycle for encoding the data and the reading cycle for decoding the data.

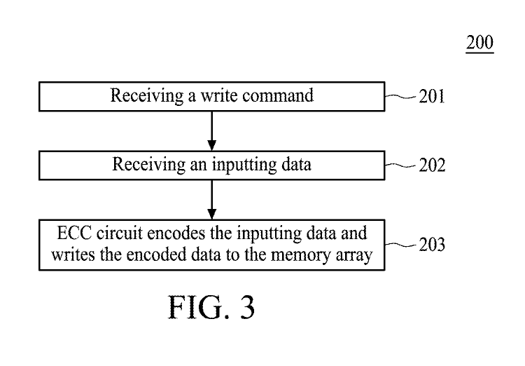

FIG. 3 is a flow chart of a method 200 of operating a comparative DRAM such as the one shown in FIG. 2. The method 200 begins with an operation 201, in which the control circuit 20 receives a write command from an external device, for example, a controller. Next, the method 200 proceeds to an operation 202, in which the control circuit 20 receives an inputting data from an external device, for example, a peripheral device using the DMA or another memory array (e.g., a different memory bank). Subsequently, the method 200 continues to an operation 203, in which the ECC circuit 40 encodes the inputting data and then performs a writing operation to write the encoded data to the memory rows of the memory array 30 according to the assigned memory address.

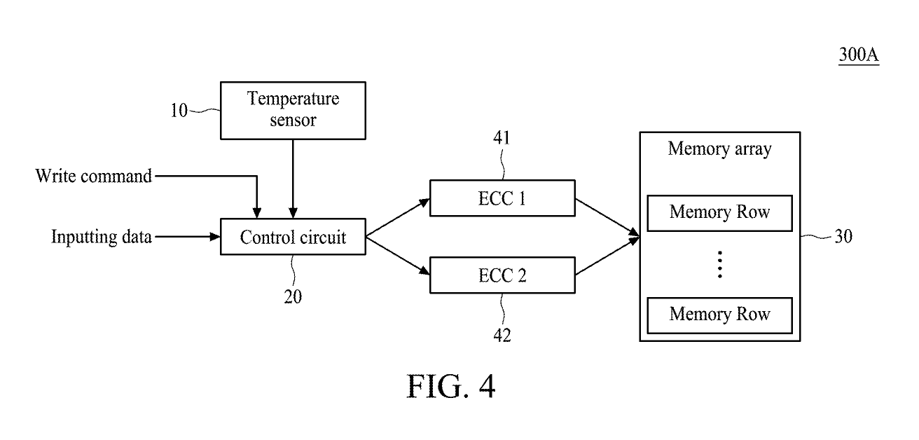

FIG. 4 is a block diagram of a DRAM 300A, in accordance with some embodiments of the present disclosure. Referring to FIG. 4, in some embodiments, the DRAM 300A includes a temperature sensor 10, a control circuit 20 connected to the temperature sensor 10, a memory array 30, a first error-correction code (ECC1) circuit 41 connected to the control circuit 20 and the memory array 30, and a second error-correction code (ECC2) circuit 42 connected to the control circuit 20 and the memory array 30.

In some embodiments, the temperature sensor 10 is configured to sense the ambient temperature of the DRAM 300A and to provide the temperature signal indicating the ambient temperature or a temperature range to the control circuit 20.

In some embodiments, the control circuit 20 is configured to receive an inputting data from an external device, for example, a peripheral device using the DMA or another memory array (e.g., a different memory bank), a write command from an external device (e.g., a controller), and the temperature signal from the sensor 10. In some embodiments, the control circuit 20 interprets the temperature signal from the temperature sensor 10. In some embodiments, the control circuit 20 checks whether the temperature sensed by the temperature sensor 10 is higher than a threshold temperature, and then determines which error-correction code (i.e., ECC1 or ECC2) circuit is to be enabled to perform an encoding operation according to the checking result.

In some embodiments, the memory array 30 includes a plurality of memory rows and is configured to store a data, for example, a user-inputting, data or a data from an external permanent hard disk.

As shown in FIG. 4, in the exemplary embodiment, the correcting ability of the ECC2 circuit 42 is better than that of the ECC1 circuit 41, and thus the ECC2 42 is used at higher temperatures, for example, above 90 degrees Celsius, while the ECC1 circuit 41 is used in lower temperature situations, for example, below 90 degrees Celsius.

In some embodiments, the ECC1 circuit 41 is configured to encode the inputting data from the control circuit 20 and to perform a writing operation to write the encoded data to the memory array 30 according to the assigned memory address after receiving the write command and the encoded data.

In some embodiments, the ECC2 circuit 42 is configured to encode the inputting data from the control circuit 20 and to perform a writing operation on the encoded data to the memory array 30 according to the assigned memory address after receiving the write command and the encoded data.

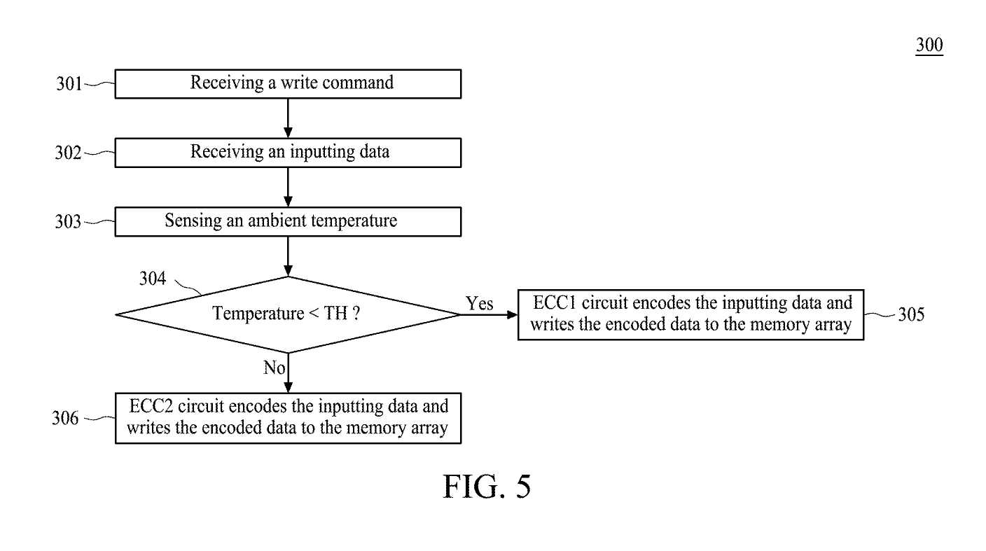

FIG. 5 is a flow chart of a method 300 of operating a DRAM such as the DRAM shown in FIG. 4. Referring to FIG. 5, the method 300 begins with an operation 301, in which the control circuit 20 receives a write command from an external device, for example, a controller. Next, the method 300 proceeds to an operation 302, in which the control circuit 20 receives an inputting data from an external device, for example, a peripheral device using the DMA or another memory array (e.g., a different memory bank). Subsequently, the method 300 continues to an operation 303, in which the temperature sensor 10 senses the ambient temperature and provides a temperature signal indicating the ambient temperature or a temperature range to the control circuit 20. The method 300 then proceeds to an operation 304, in which the control circuit 20 determines whether the ambient temperature is lower than a threshold (TH) temperature.

If the checking result is affirmative (e.g., the ambient temperature is lower than the threshold temperature), the method 300 proceeds to an operation 305, in which the control circuit 20 enables the ECC1 circuit 41 to perform an encoding operation to encode the inputting data and to perform a writing operation to write the encoded data to the memory rows of the memory array 30 according to the assigned memory address after receiving the write command and the encoded data.

If the checking result is negative; e.g., the ambient temperature is not lower than (e.g., higher than) the threshold temperature, the method 300 proceeds to an operation 306, in which the control circuit 20 enables the ECC2 circuit 42 to perform an encoding operation to encode the inputting data and to perform a writing operation to write the encoded data to the memory rows of the memory array 30 according to the assigned memory address after receiving the write command and the encoded data.

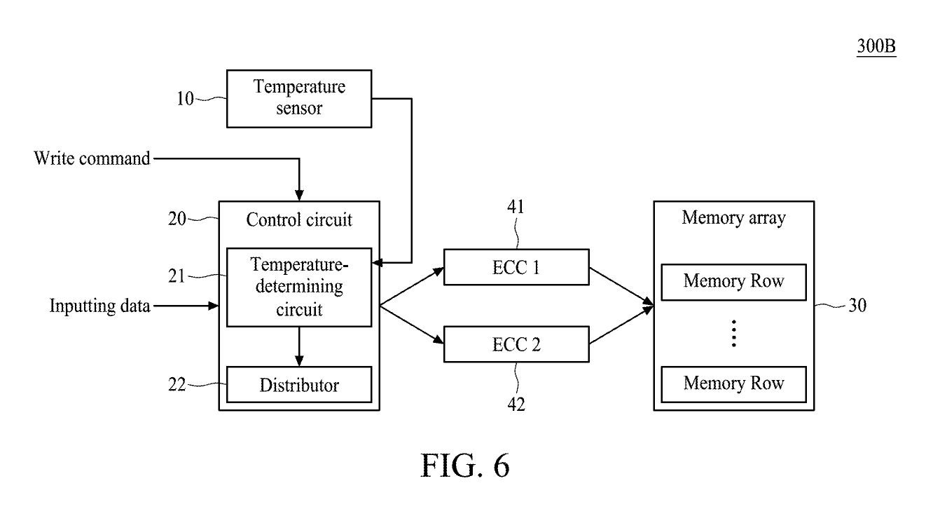

FIG. 6 is a block diagram of a DRAM 300B, in accordance with some embodiments of the present disclosure. Referring to FIG. 6, some features and functions of the DRAM 300B are the same as those described in the description of FIG. 4. Therefore, for the sake of brevity, only the differences will be described in detail. As shown in FIG. 6, in some embodiments, the control circuit 20 further includes a temperature-determining circuit 21 and a distributor 22.

In some embodiments, the temperature-determining circuit 21 is configured to interpret the temperature signal from the temperature sensor 10. In some embodiments, the temperature-determining circuit 21 determines whether the ambient temperature sensed by the temperature sensor 10 is higher than a threshold temperature, and transmits the checking result to the distributor 22.

In some embodiments, the distributor 21 is configured to determine which error-correction code (ECC) circuit, e.g., the ECC1 circuit or the ECC2 circuit, is to be enabled to perform an encode operation.

Referring back to FIG. 2, in the comparative DRAM, there is only one error-correction code (ECC) circuit to encode the inputting data; in contrast, in the DRAM of FIG. 6, there are two error-correction code (e.g., ECC1 and ECC2) circuits, in accordance with some embodiments of the present disclosure. Consequently, one error-correction code circuit having better correcting ability can be optimally applied to a situation, for example, temperatures above 90 degrees Celsius, for detecting and correcting, while another error-correction code circuit having normal correcting ability can be applied to another situation, for example, temperatures between 30 and 90 degrees Celsius, for detecting and correcting.

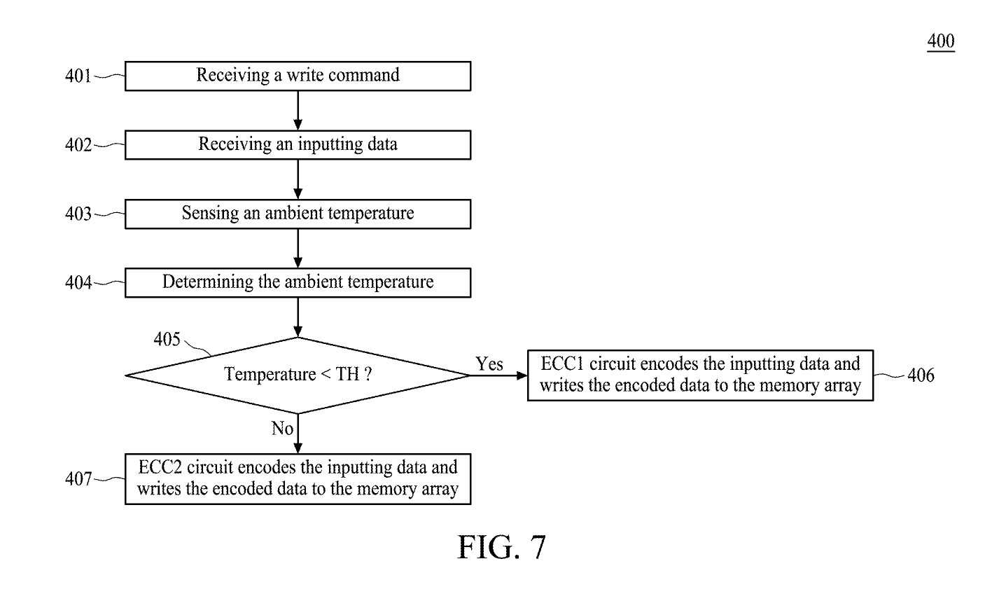

FIG. 7 is a flow chart of a method 400 of operating a DRAM such as the one shown in FIG. 6. Referring to FIG. 7, in some embodiments, the method 400 begins with an operation 401, in which the control circuit 20 receives a write command from an external device, for example, a controller. Next, the method 400 proceeds to an operation 402, in which the control circuit 20 receives an inputting data from an external device, for example, a peripheral device using the DMA or another memory array (e.g., a different memory bank). Subsequently, the method 400 continues to an operation 403, in which the temperature sensor 10 senses an ambient temperature and provides a temperature signal indicating the ambient temperature or a temperature range to the temperature-determining circuit 21. The method 400 next proceeds to an operation 404, in which the temperature-determining circuit 21 determines the ambient temperature. The method 400 then proceeds to an operation 405, in which it is determined whether the ambient temperature is less than a threshold temperature.

In some embodiments, if the checking result indicates that the ambient temperature is lower than the threshold temperature, the method 400 proceeds to an operation 406, in which the ECC1 circuit 41 is enabled to perform an encoding operation to encode the inputting data and perform a writing operation to write the encoded data to the memory rows of the memory array 30 according to the assigned memory address after receiving the write command and the encoded data.

In some embodiments, if the checking result indicates that the ambient temperature is not lower than (e.g., higher than) the threshold temperature, the method 400 proceeds to an operation 407, in which the ECC2 circuit 42 is enabled to perform an encoding operation to encode inputting data and perform a writing operation to write the encoded data to the memory rows of the memory array 30 according to the assigned memory address after receiving the write command and the encoded data.

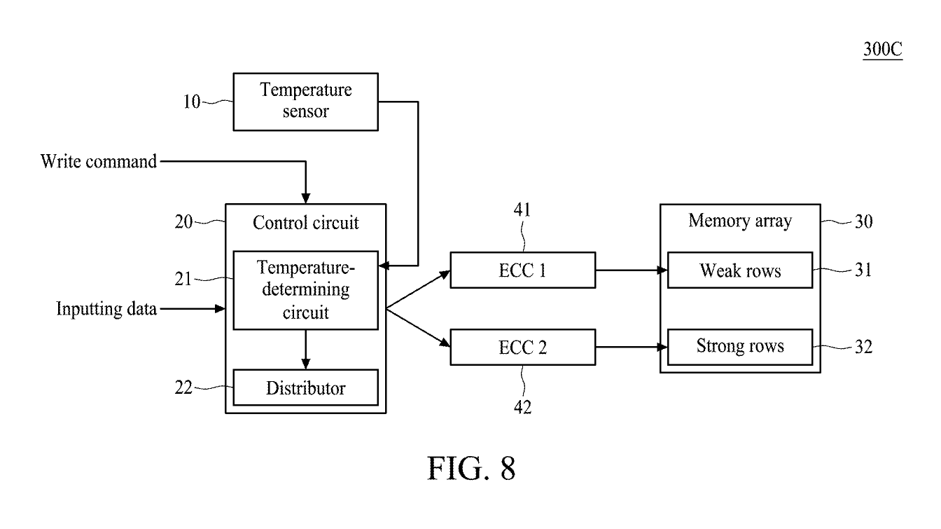

FIG. 8 is a block diagram of a DRAM 300C, in accordance with some embodiments of the present disclosure. Referring to FIG. 8, some features and functions are the same as those described in the description of FIG. 6. Therefore, for the sake of brevity, only the differences will be described in detail. As shown in FIG. 8, in some embodiments, the memory array 30 further includes a plurality of weak rows 31 and a plurality of strong rows 32.

As mentioned above, at higher temperatures, the correction ability of the ECC2 circuit 42 is better than that of the ECC1 circuit 41, and thus the ECC2 circuit 42 is used in high-temperature situations, for example, above 90 degrees Celsius, while the ECC1 circuit 41 is used at lower temperatures, for example, below 90 degrees Celsius.

In some embodiments, the plurality of weak rows is used for storing the encoded data from the ECC1 circuit. In some embodiments, the plurality of strong rows is used for storing the encoded data from the ECC2 circuit.

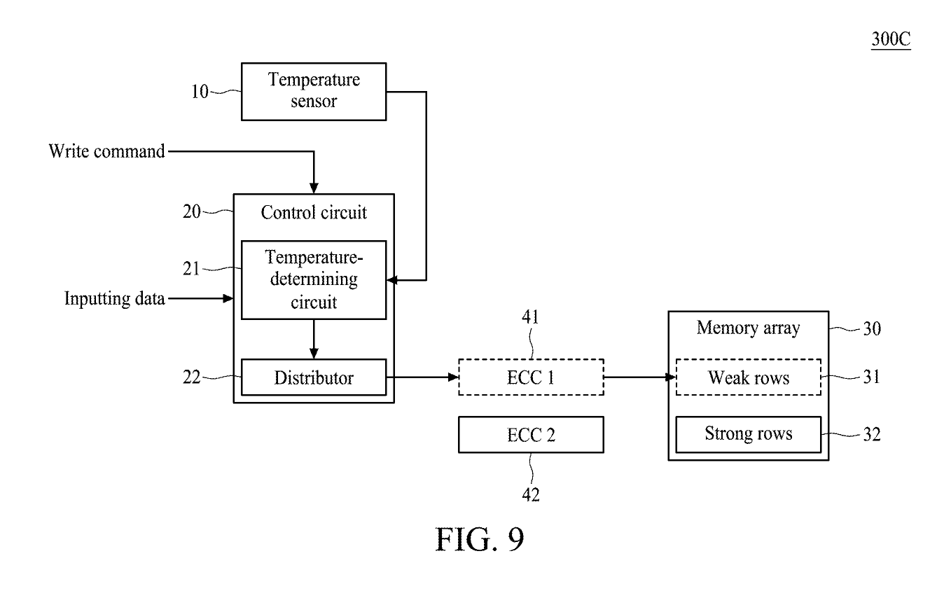

FIG. 9 is a schematic block diagram illustrating an operation of the DRAM shown in FIG. 8, in accordance with some embodiments of the present disclosure. Referring to FIG. 9, in some embodiments, the temperature sensor 10 senses the ambient temperature and transmits the sensing result to the control circuit 20. In some embodiments, the control circuit 20 includes a temperature-determining circuit 21 to interpret the sensing result from the temperature sensor 10 and then determine whether the sensing temperature exceeds a threshold temperature, for example, 90 degrees Celsius. In the exemplary embodiment in FIG. 9, the sensing temperature is lower than the threshold temperature; consequently, in some embodiments, the distributor 22 enables the ECC1 circuit 41, indicated by a dashed frame, for encoding the inputting data. In some embodiments, the ECC1 circuit 41 performs a writing operation to write the encoded data to the weak rows 31, indicated by a dashed frame, of the memory array 30 according to the assigned memory address after receiving the write command and the encoded data.

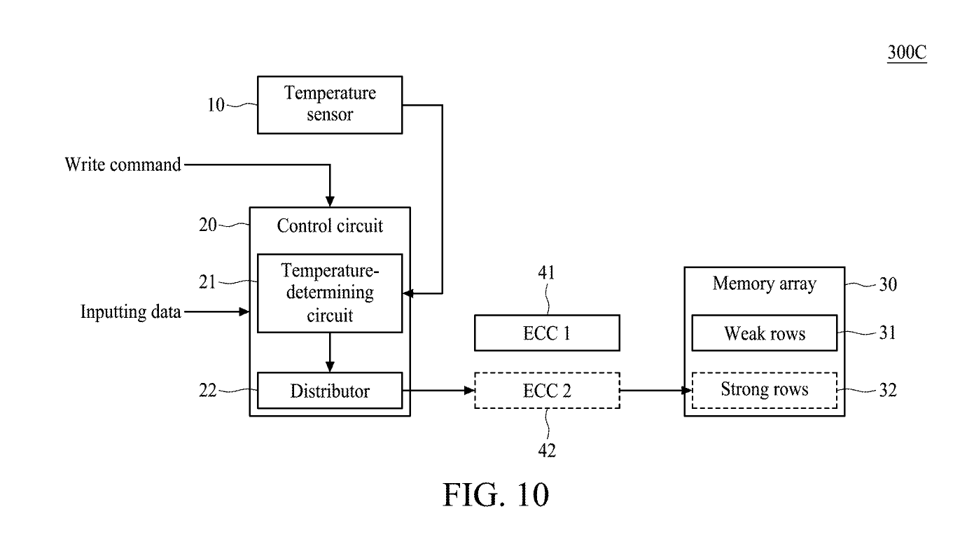

FIG. 10 is a schematic block diagram illustrating an operation of the DRAM shown in FIG. 8, in accordance with some embodiments of the present disclosure. Referring to FIG. 9, in some embodiments, the temperature sensor 10 senses the ambient temperature and transmits the sensing result to the control circuit 20. In some embodiments, the control circuit 20 includes a temperature-determining circuit 21 to interpret the sensing result from the temperature sensor 10 and then determine whether the sensing result exceeds a threshold temperature, for example, 90 degrees Celsius. In the exemplary embodiment in FIG. 10, the sensed ambient temperature is higher than the threshold temperature; consequently, in some embodiments, the distributor 22 enables the ECC2 circuit 42, indicated by a dashed frame, for encoding the inputting data. In some embodiments, the ECC2 circuit 42 performs a writing operation to write the encoded data to the strong rows 32, indicated by a dashed frame, of the memory array 30 according to the assigned memory address after receiving the write command and the encoded data.

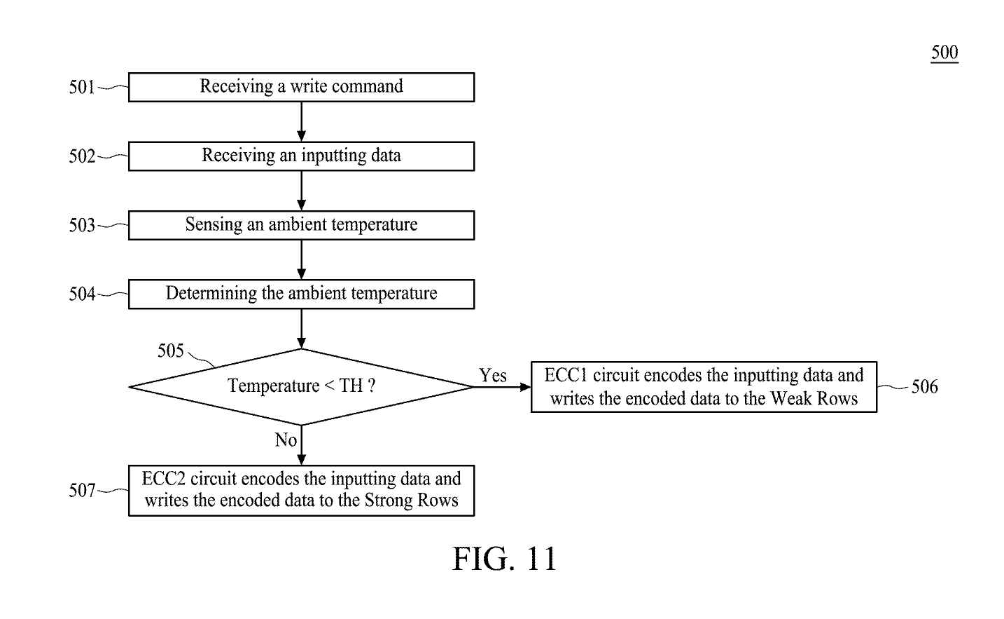

FIG. 11 is a flow chart of a method 500 of operating a DRAM such as the one shown in FIG. 8. Referring to FIG. 11, in some embodiments, the method 500 begins with an operation 501, in which the control circuit 20 receives a write command from an external device, for example, a controller. Next, the method 500 proceeds to an operation 502, in which the control circuit 20 receives an inputting data from an external device, for example, a peripheral device using the DMA or another memory array (e.g., a different memory bank). Subsequently, the method 500 continues to an operation 503, in which the temperature sensor 10 senses an ambient temperature and provides a temperature signal indicating the ambient temperature or a temperature range to temperature-determining circuit 21. The method 500 next proceeds to an operation 504, in which the temperature-determining circuit 21 interprets the temperature signal and then transmits the checking result to the distributor 22. The method 500 then proceeds to an operation 505, in which the distributor 22 determines whether the temperature is lower than the threshold temperature. In some embodiments, the distributor 22 also determines which one of the ECC1 circuit and the ECC2 circuit is to be enabled according to the checking result.

In some embodiments, if the checking result indicates that the ambient temperature is lower than the threshold temperature, the method 500 proceeds to an operation 506, in which the ECC1 circuit 41 is enabled to perform an encoding operation to encode the inputting data and perform a writing operation to write the encoded data to the weak rows 31 of the memory array 30 according to the assigned memory address after receiving the write command and the encoded data.

In some embodiments, if the checking result indicates that the ambient temperature is not lower than (e.g., higher than) the threshold temperature, the method 500 proceeds to an operation 507, in which the ECC2 circuit 42 is enabled to perform an encoding operation to encode the inputting data and perform a writing operation to write the encoded data to the strong rows 32 of the memory array 30 according to the assigned, memory address after receiving the write command and the encoded data.

In a comparative DRAM, there is only one error-correction code (ECC) circuit to encode the inputting data; in contrast, in the DRAM of the present disclosure, there are two error-correction code (e.g., ECC1 and ECC2) circuits. Consequently, one error-correction code circuit having better correcting ability can be applied to a particular situation, for example, higher temperature, while another error-correction code circuit having normal correcting ability can be applied to another situation, for example, normal temperature.

One aspect of the present disclosure provides a DRAM, comprising a memory array; a control circuit configured to receive an inputting data and a temperature signal; a first error-correction code (ECC1) circuit configured to generate a first encoded data from the inputting data; and a second error-correction code (ECC2) circuit configured to generate a second encoded data from the inputting data.

Another aspect of the present disclosure provides a DRAM, comprising a memory array; a control circuit configured to receive an inputting data and a temperature signal; a first error-correction code (ECC1) circuit configured to generate a first encoded data from the inputting data; and a second error-correction code (ECC2) circuit configured to generate a second encoded data from the inputting data, wherein the ECC1 circuit is enabled when the temperature signal indicates that an ambient temperature is lower than a threshold temperature and the ECC2 circuit is enabled when the temperature signal indicates that the ambient temperature is higher than the threshold temperature.

Another aspect of the present disclosure provides a method of operating a dynamic random-access memory, comprising the steps of receiving an inputting data; receiving a temperature signal; interpreting the temperature signal indicating an ambient temperature; determining whether the ambient temperature is lower than a threshold temperature; and enabling an error-correction code circuit based on the determining result.

Although the present disclosure and its advantages have been described in detail, it should be understood that various changes, substitutions and alterations can be made herein without departing from the spirit and scope of the disclosure as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, and composition of matter, means, methods and steps described in the specification. As one of ordinary skill in the art will readily appreciate from the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A dynamic random-access memory (DRAM), comprising:
a memory array;
a control circuit configured to receive an inputting data and a temperature signal;
a first error-correction code (ECC1) circuit configured to generate a first encoded data from the inputting data; and
a second error-correction code (ECC2) circuit configured to generate a second encoded data from the inputting data.

2. The DRAM of claim 1, wherein the ECC1 circuit is configured to generate the first encoded data when the temperature signal indicates that an ambient temperature is lower than a threshold temperature.

3. The DRAM of claim 1, wherein the ECC2 circuit is configured to generate the second encoded data when the temperature signal indicates that an ambient temperature is higher than a threshold temperature.

4. The DRAM of claim 1, wherein the control circuit is configured to determine which one of the ECC1 circuit and the ECC2 circuit is to be enabled.

5. The DRAM of claim 1, further comprising a temperature sensor configured to generate the temperature signal representing the ambient temperature.

6. The DRAM of claim 1, wherein the control circuit is configured to receive a write command.

7. The DRAM of claim 6 wherein one of the ECC1 circuit and the ECC2 circuit is configured to perform a writing operation to the memory array after receiving the write command and one of the first encoded data and the second encoded data.

8. A dynamic random-access memory (DRAM), comprising:
a memory array;
a control circuit configured to receive an inputting data and a temperature signal;
a first error-correction code (ECC1) circuit configured to generate a first encoded data from the inputting data; and
a second error-correction code (ECC2) circuit configured to generate a second encoded data from the inputting data, wherein the ECC1 circuit is enabled when the temperature signal indicates that an ambient temperature is lower than a threshold temperature and the ECC2 circuit is enabled when the temperature signal indicates that the ambient temperature is higher than the threshold temperature.

9. The DRAM of claim 8, wherein the control circuit comprises a temperature-determining circuit configured to interpret the temperature signal representing the ambient temperature.

10. The DRAM of claim 8, wherein the control circuit further comprises a distributor configured to determine which one of the ECC1 circuit and the ECC2 circuit is to be enabled.

11. The DRAM of claim 8, further comprising a temperature sensor to generate the temperature signal representing the ambient temperature.

12. The DRAM of claim 8, wherein the control circuit is configured to receive a write command.

13. The DRAM of claim 12, wherein one of the ECC1 circuit and the ECC2 circuit is configured to perform a writing operation to the memory array after receiving the write command and one of the first encoded data and the second encoded data.

14. The DRAM of claim 8, wherein the memory array comprises at least one weak row and at least one strong row.

15. The DRAM of claim 14, wherein the first encoded data is stored in the weak row.

16. The DRAM of claim 14, wherein the second encoded data is stored in the strong row.

17. A method of operating a dynamic random-access memory, comprising the steps of:
receiving an inputting data;
receiving a temperature signal;
interpreting the temperature signal indicating an ambient temperature;
determining whether the ambient temperature is lower than a threshold temperature; and
enabling one of at least two error-correction code circuits based on the determining result.

18. The method of claim 17, wherein the step of enabling one of at least two error-correction code circuits based on the determining result includes encoding the inputting data to generate an encoded data, and the method further comprises a step of writing the encoded data to a memory array.

19. The method of claim 18, wherein the step of writing the encoded data to a memory array comprises writing the encoded data in weak rows of the memory array if the ambient temperature is lower than the threshold temperature.

20. The method of claim 18, wherein the step of writing the encoded data to a memory array comprises writing the encoded data in strong rows of the memory array if the ambient temperature is not lower than the threshold temperature.
